(19) United States
(12) Patent Application Publication
(10) Pub. No.: US 2026/0259597 A1
(43) Pub. Date: Sep. 3, 2026

(54) BIOMETRICALLY CONTROLLED AUDIO EMITTING SYSTEM

(71) Applicant: BOSE CORPORATION, Framingham, MA (US)

(72) Inventors: Thomas David CHAMBERS, Bellingham, MA (US); Serena LIN, Basking Ridge, NJ (US); Lucia Snyder BRIMMER, Minnetonka, MN (US)

(21) Appl. No.: 19/069,115

(22) Filed: Mar. 3, 2025

(51) Int. Cl. G06F 3/01; G06F 3/16; G06V 40/12; G06V 40/13

(52) U.S. Cl. CPC G06F 3/011; G06F 3/162; G06F 3/165; G06V 40/13; G06V 40/1365

(57) ABSTRACT

Aspects of the present disclosure provide a system configured to emit audio. The system including an audio emitting device, a controller configured to control one or more operations of the audio emitting device, and a biometric sensor. The biometric sensor is in communication with the controller. The controller is configured to receive a first biometric input from the biometric sensor and is configured to cause the audio emitting device to conduct a first operation of the one or more operations based on the first biometric input.

### BACKGROUND

The present disclosure generally relates to an audio emitting system controllable by biometric information. Audio emitting systems typically include various settings and programs that may be cumbersome or time consuming to select or change. Thus, there is a need for a more efficient and dynamic audio emitting system controllable by biometric information.

### SUMMARY

All examples and features mentioned below can be combined in any technically possible way.

Aspects of the present disclosure provide a system configured to emit audio. The system including an audio emitting device, a controller configured to control one or more operations of the audio emitting device, and a biometric sensor. The biometric sensor is in communication with the controller. The controller is configured to receive a first biometric input from the biometric sensor and is configured to cause the audio emitting device to conduct a first operation of the one or more operations based on the first biometric input.

In aspects, the controller is configured to receive a second biometric input different from the first biometric input from the biometric sensor and is configured to cause the audio emitting device to conduct a second operation of the one or more operations based on the second biometric input.

In aspects, the first biometric input is received from a first person and the second biometric input is received from the first person.

In aspects, the first biometric input is a first fingerprint and the second biometric input is a second fingerprint different from the first fingerprint.

In aspects, the first biometric input is received from a first person and the second biometric input is received from a second person.

In aspects, the biometric sensor is a fingerprint scanner and the first biometric input is a fingerprint.

In aspects, the audio emitting device is wirelessly coupled to the controller

In aspects, the first operation comprises emitting a first audio.

In aspects, the first operation comprises adjusting a setting of the audio emitting device.

Aspects of the present disclosure provide a method for controlling an audio emitting device. The method including receiving a first biometric input from a biometric sensor, causing an audio emitting device to conduct a first operation based on the first biometric input, receiving a second biometric input from the biometric sensor and causing the audio emitting device to conduct a second operation based on the second biometric input.

In aspects, the method further includes identifying the first biometric input is associated with a first person and the first operation is based on the first biometric input and the identity of the first person.

In aspects, the method further includes identifying the second biometric input is associated with the first person and the second operation is based on the second biometric input and the identity of the first person.

In aspects, the method further includes identifying the second biometric input is associated with a second person and the second operation is based on the second biometric input and the identity of the second person.

In aspects, causing the audio emitting device to conduct the first operation based on the first biometric input includes: communicating with an external device, the external device including a relationship between the first biometric input and the first operation and causing the audio emitting device to conduct the first operation based on the relationship between the first biometric input and the first operation.

In aspects, the method further includes providing a first feedback after receiving the first biometric input and the first feedback comprises an indication of the first operation commencing.

In aspects, the first operation comprises emitting a first audio.

In aspects, the first operation comprises adjusting a setting of the audio emitting device.

Aspects of the present disclosure provide a non-transitory computer-readable medium including instructions stored thereon that when executed by one or more processors cause a control system to control an audio emitting device to conduct one or more operations. The controlling includes receiving a first biometric input from a biometric sensor, causing an audio emitting device to conduct a first operation based on the first biometric input, receiving a second biometric input from the biometric sensor, and causing the audio emitting device to conduct a second operation based on the second biometric input.

In aspects, the controlling further includes identifying the first biometric input is associated with a first person, and wherein the first operation is based on the first biometric input and the identity of the first person.

In aspects, the controlling further includes identifying the second biometric input is associated with a second person, and wherein the second operation is based on the second biometric input and the identity of the second person.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 illustrates an exemplary biometrically controlled audio emitting system, according to one or more aspects.

FIGS. 2A-2C illustrate exemplary biometrically controlled audio emitting systems, according to one or more aspects.

FIG. 3 illustrates a first user’s hands and a second user’s hands, according to one or more aspects.

FIG. 4 illustrates a method for controlling an audio emitting device, according to one or more aspects.

### DETAILED DESCRIPTION

In aspects, the disclosure contemplates that terms such as “couples,” “coupling,” “couple,” and “coupled” may include but are not limited to integrally forming. In aspects, the disclosure contemplates that terms such as “couples,” “coupling,” “couple,” and “coupled” may include but are not limited to direct coupling and/or indirect coupling, such as indirect coupling through intermediate components.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the headphones herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Aspects of the present disclosure provide systems, apparatus, and methods regarding a biometrically controlled audio emitting system including an audio emitting device, a biometric sensor, and a controller wherein the controller receives a biometric input from the biometric sensor and instructs the audio emitting device to take some action and/or operate in some way based on the biometric input.

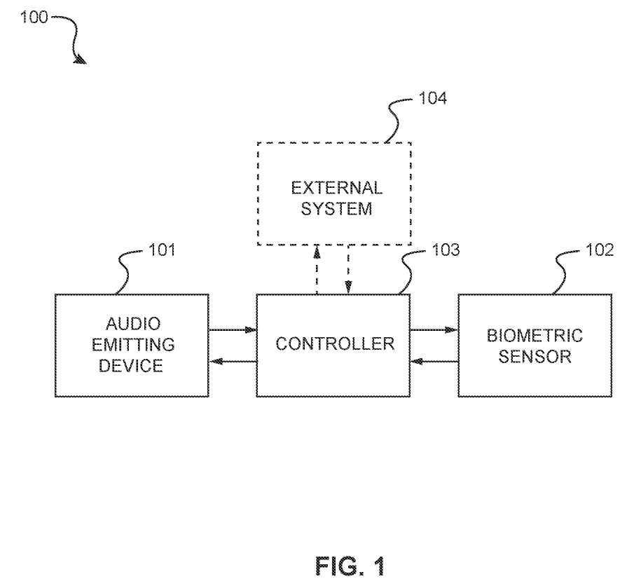

FIG. 1 illustrates an exemplary biometrically controlled audio emitting system 100. The exemplary system 100 includes an audio emitting device 101, a biometric sensor 102, and a controller 103.

The audio emitting device 101 may be any device configured to emit audio (e.g., music or other sounds). Although described as an audio emitting device, the audio emitting device 101 may include other components and/or functions including, but not limited to, lights, microphones, and screens. In one or more embodiments, the audio emitting device 101 is headphones or earphones and may be in ear, over ear, or on ear headphones. In one or more embodiments, the audio emitting device 101 may be a speaker.

The audio emitting device 101 is communicatively coupled to the controller 103. The controller 103 is configured to control the audio emitting device 101 (e.g., instruct the audio emitting device 101 to take some action and/or operate in some way). In one or more embodiments, the controller 103 instructs the audio emitting device 101 to emit specific audio (e.g., specific music). In one or more embodiments, the controller 103 instructs the audio emitting device 101 to change settings (e.g., volume, bass level, treble level) or modes.

The controller 103 may include a programmable central processing unit (CPU) which is operable with a memory (e.g., non-transitory computer readable medium and/or non-volatile memory) and support circuits. The support circuits are coupled to the CPU and includes cache, clock circuits, input/output subsystems, power supplies, and the like, and combinations thereof coupled to the various components of the system 100, to facilitate performing one or more operations of method 400. For example, in one or more embodiments the CPU is one of any form of general purpose computer processor used in a consumer product setting, such as a microcontroller, for controlling various electronic devices (e.g., cell phones, audio emitting devices, lights, computers, etc.). The memory, coupled to the CPU, is non-transitory and is one or more of readily available memory such as random access memory (RAM), read only memory (ROM), floppy disk drive, hard disk, or any other form of digital storage, local or remote.

Herein, the memory is in the form of a computer-readable storage media containing instructions (e.g., non-volatile memory), that when executed by the CPU, facilitates the communication of biometric information, instructions, data, settings, etc. between one or more of the components of the system 100. The instructions in the memory are in the form of a program product such as a program that implements the methods of the present disclosure (e.g., middleware application, equipment software application, etc.). The program code may conform to any one of a number of different programming languages. In one or more embodiments, the disclosure may be implemented as a program product stored on computer-readable storage media for use with a computer system. The program(s) of the program product define functions of the embodiments (including the methods and operations described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure.

The various methods (such as method 400) and operations disclosed herein may generally be implemented under the control of the CPU of the controller 103 by the CPU executing computer instruction code stored in the memory as, e.g., a software routine. When the computer instruction code is executed by the CPU, the CPU conducts operations in accordance with the various methods and operations described herein. In one or more embodiments, the memory (a non-transitory computer readable medium) includes instructions stored therein that, when executed, cause the method (such as the method 400) described herein to be conducted. The operations described herein can be stored in the memory in the form of computer readable logic.

The biometric sensor 102 is configured to receive a biometric input from a user. In one or more embodiments, the biometric sensor 102 may include one or more biometric sensors 102 which may be configured to receive the same or different types of biometric inputs. In one or more embodiments, the biometric sensor 102 is a fingerprint scanner. In such embodiments, the biometric sensor 102 is configured to receive fingerprints. In one or more embodiments, the biometric sensor 102 is a camera configured to scan or take a picture of some biometric identifying feature of a user. For instance the biometric sensor 102 may an eye scanner and is configured to scan the eye(s) of a user or a face scanner configured to scan the face of a user. Still in one or more embodiments, the biometric sensor 102 can be any sensor or measurement device configured to receive a biometric input from a user using the system 100 so as to identify the user using the system 100.

The biometric sensor 102 is communicatively coupled to the controller 103. In one or more embodiments, the biometric sensor 102 and the controller 103 are communicatively coupled by a wired connection or by a wireless connection (e.g., Bluetooth, WiFi, or internet connection). the biometric sensor 102 sends (and the controller 103 receives) the one or more biometric inputs. The controller 103 is then able to use that biometric input to instruct the audio emitting device 101 to take some action and/or operate in some way. For instance, the controller 103 can use the biometric input to identify the user and cause the audio emitting device 101 to take some action and/or operate in some way based on the identity of the user. As another example, the controller 103 can use the biometric input to identify the user and the specific type of biometric input (e.g., finger print, eye scan, etc.) to cause the audio emitting device 101 to take some action and/or operate in some way.

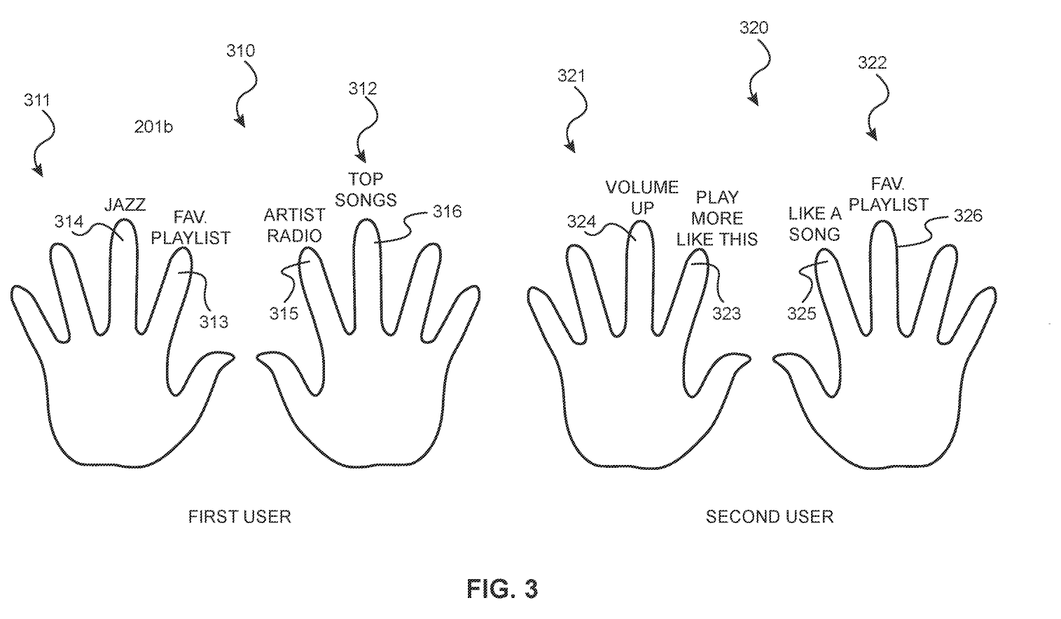

According to an exemplary mode of operation, a user inputs a biometric input into the biometric sensor 102. The controller 103 receives (and the biometric sensor 102 sends) the biometric input. The controller 103 utilizes the biometric input to determine the audio emitting device 101 is to take some action and/or operate in some way. That action and/or operation may be related to the identity of the user input (e.g., if user A provides a biometric input, play jazz music and if user B provides a biometric input, play rock-n-roll music) and/or to the type of biometric input (e.g., if user A provides an index fingerprint, turn the volume up and, if user A provides a thumbprint, play rock-n-roll). The relationships between the biometric input and desired actions/operations is described in more detail with respect to FIG. 3 below. The controller 103 then instructs the audio emitting device 101 to act/operate based on the biometric input.

In one or more embodiments, the system 100 further includes an external system 104 in communication with the controller 103. In one or more embodiments, the external system 104 may be a server or a device (e.g., a computer or phone). The external system 104 may be used to store information to be accessed by the controller 103. In one or more embodiments, the external system 104 stores the relationship between various biometric inputs and desired actions/operation. In one or more embodiments, the external system 104 can store user profile(s) and such user profile(s) are configurable to set a relationship between biometric inputs and desired operations/actions. For example, the user profile(s) are configurable to set relationships between user(s), their biometric inputs, and desired operations and/or actions. As a non-limiting example, the external system 104 can include the user profile of a first user where the first user’s index fingerprint causes the audio emitting device 101 to emit a specific sound and where the first user’s thumbprint causes the audio emitting device 101 to turn the volume up on the audio emitting device 101. As another non-limiting example, the external system 104 can include another user profile of a second user where the second user’s index finger causes the audio emitting device 101 to play a specific radio station and where the second user’s thumbprint causes the audio emitting device 101 to turn off.

According to one non-limiting example, the controller 103 may receive a biometric input from the biometric sensor 102. The controller 103 may then determine, based on the biometric input, a desired selection of music be played by accessing a user profile stored in the external system 104. Based on that determination, the controller 103 may then instruct the audio emitting device 101 to play the music selection.

Furthermore, in one or more embodiments, the external system 104 stores the instructions for the desired actions or the output of the desired actions (i.e., the audio to be played, the desired setting, the desired mode, etc.)

In one or more embodiments, the external system 104 may be a computing device 104 (e.g. cell phone or computer). The computing device 104 may include an application (“app”) for playing music, storing instructions to take certain actions, and/or for storing the relationships between biometric inputs and actions/operations.

According to one non-limiting example, the controller 103 may receive a biometric input from the biometric sensor 102. The controller 103 may then determine, based on the biometric input, a desired selection of music be played. Based on that determination, the controller 103 may access the app on the computing device 104 to retrieve the desired music selection. The controller 103 may then instruct the audio emitting device 101 to play the retrieved music selection.

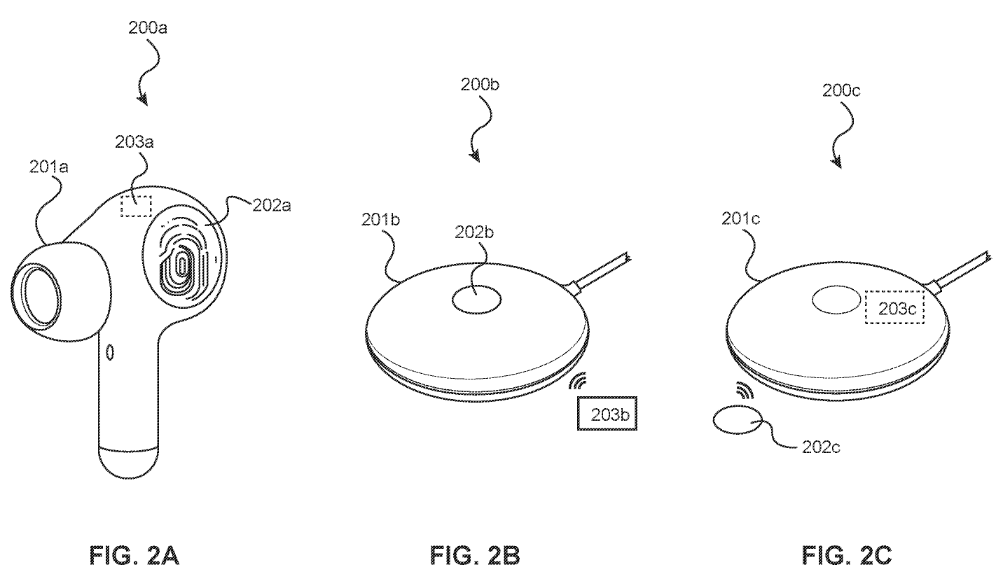

As will be described in further detail with respect to FIGS. 2A-2C, any one or more of the components of the system 100 may be integrally formed or may be separate. In the case of separate components, the system 100 may communicate by a wired connection or by a wireless connection.

FIGS. 2A-2C illustrate exemplary biometrically controlled audio emitting systems 200a, 200b, 200c. FIG. 2A illustrates exemplary system 200a. Exemplary system 200a includes an audio emitting device 201a with an integral biometric sensor 202a and controller 203a. In the illustrated embodiment, the audio emitting device 201a is a headphone 201a and the biometric sensor 202a is a fingerprint scanner 202a integral to the headphone 201a. According to one mode of operation, a user wearing the headphone 201a scans a fingerprint of one of their fingers with the fingerprint scanner 202a which causes the controller 203a to instruct the headphone 201a to take some action and/or operate in some way.

FIG. 2B illustrates exemplary system 200b. Exemplary system 200b includes an audio emitting device 201b with an integral biometric sensor 202b and a separate controller 203b connected to (e.g., by a wireless or wired connection) the audio emitting device 201b and the biometric sensor 202b. In the illustrated embodiment, the audio emitting device 201b is a speaker 201b and the biometric sensor 202b is a fingerprint scanner 202b integral to the speaker 201b. According to one mode of operation, a user using the speaker 201b scans a fingerprint of one of their fingers with the fingerprint scanner 202b which causes the separate controller 203b to instruct the speaker 201b to take some action and/or operate in some way.

FIG. 2C illustrates exemplary system 200c. Exemplary system 200c includes an audio emitting device 201c with an integral controller 203c and a separate biometric sensor 202c connected to (e.g., by a wireless or wired connection) the audio emitting device 201b and the controller 203c. In the illustrated embodiment, the audio emitting device 201c is a speaker 201c and the biometric sensor 202c is a fingerprint scanner 202c separate from the speaker 201c. According to one mode of operation, a user using the speaker 201c scans a fingerprint of one of their fingers with the fingerprint scanner 202c which causes the controller 203c to instruct the speaker 201c to take some action and/or operate in some way.

FIG. 3 illustrates a first user’s hands 310 and a second user’s hands 320. As previously mentioned, the biometric sensor of the system may be a fingerprint scanner and the audio emitting device of the system is instructed to take some action and/or operate in some way based on the input to the fingerprint scanner. Accordingly, FIG. 3 illustrates possible relationships between fingerprints of a first user’s hands 310 and desired actions/operations and the relationships between the fingerprints of a second user’s hands 320 and desired actions/operations. Although the following description is related to fingers and fingerprints, it is understood that the below description is exemplary and may be applicable to any number of biometric inputs.

A first user’s hands 310 include a first hand 311 and a second hand 312. The first hand 311 includes a first finger 313 with a first fingerprint and a second finger 314 with a second fingerprint. The first user’s second hand 312 includes a third finger 315 with a third fingerprint and a fourth finger 316 with a fourth fingerprint.

A second user’s hands 320 include a first hand 321 and a second hand 322. The first hand 321 includes a first finger 323 with a first fingerprint and a second finger 324 with a second fingerprint. The second user’s second hand 322 includes a third finger 325 with a third fingerprint and a fourth finger 326 with a fourth fingerprint. Although only four fingers and fingerprints are described for each user, it should be understood that all of a user’s fingers and fingerprints may cause a controller of a system to instruct an audio emitting device to take some action and those actions may be different from one another or the same.

As illustrated, if the first user were to use their first finger 313 with the system, the controller would instruct the audio emitting device to play their favorite playlist. Accordingly, the controller would identify that the biometric input came from the first user and that the first user used their first finger 313 indicating the desired action was to play their favorite playlist. Whereas, if the first user were to use their second finger 314 with the system, the controller would instruct the audio emitting device to play jazz music. Accordingly, the controller would identify that the biometric input came from the first user and that the first user used their second finger 314 indicating the desired action was to play jazz music. However, if the first user were to use their third finger 315 with the system, the controller would instruct the audio emitting device to play a radio station based on the artist of the music currently playing (“Artist Radio”). Accordingly, the controller would identify that the biometric input came from the first user and that the first user used their third finger 315 indicating the desired action was to play the Artist Radio. Whereas if the first user were to use their fourth finger 316 with the system, the controller would instruct the audio emitting device to play the user’s top rated songs (“Top Songs”). Accordingly, the controller would identify that the biometric input came from the first user and that the first user used their fourth finger 316 indicating the desired action was to play Top Songs.

Similarly, if the second user were to use their first finger 323 with the system, the controller would instruct the audio emitting device to play more songs like the one currently playing (“Play More Like This”). Accordingly, the controller would identify that the biometric input came from the second user and that the second user used their first finger 323 indicating the desired action was to Play More Like This. Whereas, if the second user were to use their second finger 324 with the system, the controller would instruct the audio emitting device to turn the volume up. Accordingly, the controller would identify that the biometric input came from the second user and that the second user used their second finger 324 indicating the desired action was to turn the volume up. However, if the second user were to use their third finger 325 with the system, the controller would instruct the audio emitting device to “like” a currently playing song. Accordingly, the controller would identify that the biometric input came from the second user and that the second user used their third finger 325 indicating the desired action was to “like” the currently playing song. Whereas if the second user were to use their fourth finger 326 with the system, the controller would instruct the audio emitting device to play the user’s favorite playlist. Accordingly, the controller would identify that the biometric input came from the second user and that the second user used their fourth finger 326 indicating the desired action was to play the user’s favorite playlist.

Thus, the controller identifies both the user and the specific biometric input and uses the identity of the user and the identity of the specific biometric input to cause the audio emitting device to take some action.

In one or more embodiments, the biometric input may further include a combination or sequence of biometric inputs. For instance, if a user were to use their first finger and then their second finger, it could indicate to the controller to cause the audio emitting device to take some action which may be different from the actions taken when only the first finger or second finger were used. As another example, if a user were to use two fingers simultaneously, it could indicate to the controller to cause the audio emitting device to take some action which may be different from the actions taken when only the first finger or second finger were used.

In one or more embodiments, the biometric input may further include a sequence or combination of biometric inputs from different users. As an example, a first user could use their first finger and then the second user could use their first finger, which could indicate to the controller to cause the audio emitting device to take some action which may be different from the actions taken when only the first finger of the first user or first finger of the second user were used. As another example, if a first user and a second user were to use their fingers simultaneously, it could indicate to the controller to cause the audio emitting device to take some action which may be different from the actions taken when only one finger of each was used.

In one or more embodiments, an action may be based simply on the indication that different user (e.g., different from the previous or current user) has used the biometric sensor. As an example, if a second user uses the biometric sensor while a first user is using, or previously used, the system, it could indicate to the controller to switch to preferred settings of the second user. As another example if a second user uses the biometric sensor, while a first user is using, or previously used, the system, it could indicate to the controller to queue up a song or songs based on the second user’s input.

Accordingly, the actions that may be taken by the audio emitting device may be based on identity of the user, based on the specific biometric inputs (e.g. a specific fingerprint) supplied by the user or users, and/or based on a combination, timing, or sequence of specific biometric inputs.

According to one or more embodiments, possible desired actions/operations may include, but are not limited to playing particular audio (e.g., a playlist, an artist, a radio station, a song, a set of songs, a genre, a song/artist/genre based on currently playing audio), accessing a particular audio source (e.g., an application, a radio station, a webpage), altering a setting of the audio emitting device (e.g., changing volume, changing EQ or noise canceling settings, muting or unmuting a microphone of the audio emitting device, or changing audio characteristics like bass or treble), accessing features of the audio source (e.g., “liking” a song, adding a song to a playlist), or other actions (like turning on lights or LEDs attached to, or associated with, the audio emitting device). In one or more embodiments, another possible desired action/operation could include emitting audio from more than one audio emitting device (e.g., a desired action could be emitting audio from two speakers rather than one or from a particular speaker and/or subset of speakers from a group of speakers).

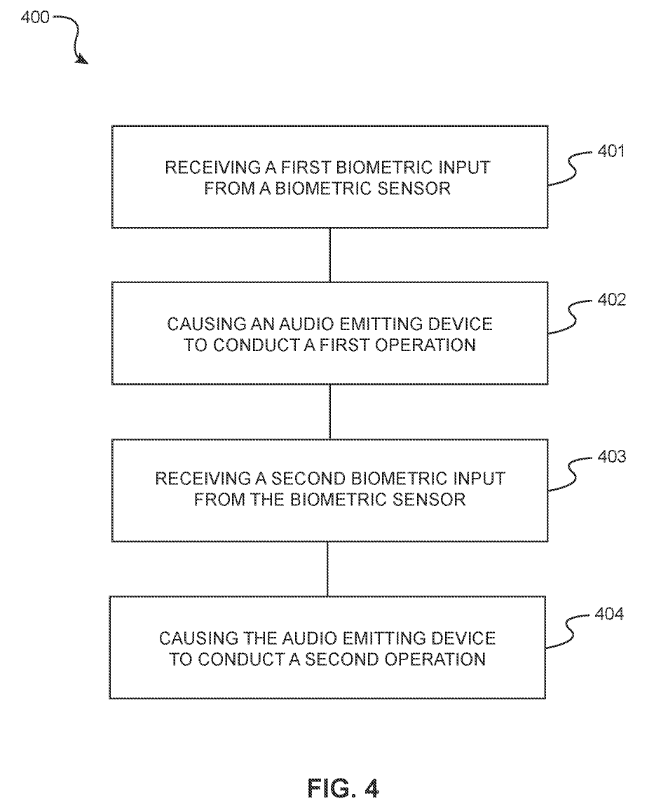

FIG. 4 illustrates a method 400 for controlling an audio emitting device (such as audio emitting device 101 of FIG. 1).

At operation 401, a controller (such as controller 103 of FIG. 1) receives a first biometric input from a biometric sensor (such as biometric sensor 102 of FIG. 1) communicatively coupled to the controller. In one or more embodiments, one or more of the biometric sensor, audio emitting device and the controller are integral one another. In one or more embodiments, one or more of the biometric sensor, the audio emitting device, and the controller are communicatively coupled by a wired or wireless connection.

In one or more embodiments, the biometric input may be a fingerprint or any other biometric input previously mentioned. Accordingly, the biometric sensor may be a fingerprint scanner or any other biometric sensor configured to receive a corresponding biometric input form a user. In one or more embodiments the first biometric input may be a biometric input from a first user.

At operation 402, the controller causes the audio emitting device to conduct a first operation based on the first biometric input. As previously indicated, the first biometric input has a corresponding operation and/or action such that when the controller receives the first biometric input, the controller causes the audio emitting device to act and/or operate in a specific way. In one or more embodiments, the operation and/or action is based on the first biometric input itself (e.g., the fingerprint of the first finger of a user) and/or identity of the user which is determinable by the first biometric input (e.g., the fingerprint of the first user not only identifies the first user but identifies the finger being used by the first user). In one or more embodiments, the first operation includes a desired setting, user profile, or audio (e.g., song, music, and/or playlist) associated with the first biometric input. In one or more embodiments, the first operation could be any listed above with regards to FIG. 3.

In one or more embodiments, causing the audio emitting device to conduct the first operation includes communicating with an external device (such as external system 104 of FIG. 1) that includes a memory storing the relationship between the first biometric input and the first operation. As such, the controller can access the stored relationships stored on the external device.

In one or more embodiments, causing the audio emitting device to conduct the first operation further includes accessing the external device which includes the desired output (e.g., the sounds or music the audio emitting device is instructed to emit). As a non-limiting example, the external device is a phone and the phone includes stored music or music stored in an application (e.g. “app”).

At operation 403, the controller receives a second biometric input from the biometric sensor. In some embodiments the second biometric input may be from the same user (e.g., a fingerprint from another finger or an entirely different type of biometric input from the same user). In some embodiments, the second biometric input may be from a different user.

At operation 404 the controller causes the audio emitting device to conduct a second operation based on the second biometric input. As previously indicated, the second biometric input has a corresponding operation and/or action such that when the controller receives the second biometric input, the controller causes the audio emitting device to act and/or operate in a specific way. In one or more embodiments, the operation and/or action is based on the second biometric input itself (e.g., the fingerprint of the first finger of the second user or the fingerprint of the second finger of the first user) and/or identity of the user (e.g., a second user) which is determinable by the second biometric input (e.g., the fingerprint of the first user not only identifies the first user but identifies the finger being used by the first user).

In one or more embodiments, the first biometric input and/or the second biometric input includes a combination, sequence, or timing of individual biometric inputs from one or more users, as described in more detail above with respect to FIG. 3.

In one or more embodiments, the method 400 also includes providing feedback to the user(s) of the system. For example, in one or more embodiments, the audio emitting device and/or external device may indicate to the user which operation is commencing or is about to commence before the first and/or second operation commences (i.e., the audio emitting device may announce that it is about to play the second user’s favorite song based on receiving a particular biometric input). The indication may be an audio or visual indication (i.e., on a screen or with lights). In one or more embodiments, providing feedback may include indicating to the user that the desired operation and/or action has failed.

Any one or more components of the system 100 may be integrally formed together, directly coupled together, and/or indirectly coupled together and are not limited to the specific arrangement of components illustrated in FIGS. 1-4. Any one or more of the components or embodiments of the system 100 may be combined in whole or part with any other components or embodiments of the system 100. Any one or more of the steps, operations, or embodiments of the method 400 may be combined in whole or part with any other components or embodiments of the method 400.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A system configured to emit audio, comprising:
an audio emitting device;
a controller configured to control one or more operations of the audio emitting device; and
a biometric sensor in communication with the controller, wherein the controller is configured to receive a first biometric input from the biometric sensor and is configured to cause the audio emitting device to conduct a first operation of the one or more operations based on the first biometric input.

2. The system of claim 1, wherein the controller is configured to receive a second biometric input different from the first biometric input from the biometric sensor and is configured to cause the audio emitting device to conduct a second operation of the one or more operations based on the second biometric input.

3. The system of claim 2, wherein the first biometric input is received from a first person, and wherein the second biometric input is received from the first person.

4. The system of claim 3, wherein the first biometric input is a first fingerprint, and wherein the second biometric input is a second fingerprint different from the first fingerprint.

5. The system of claim 2, wherein the first biometric input is received from a first person, and wherein the second biometric input is received from a second person.

6. The system of claim 1, wherein the biometric sensor is a fingerprint scanner and the first biometric input is a fingerprint.

7. The system of claim 1, wherein the audio emitting device is wirelessly coupled to the controller.

8. The system of claim 1, wherein the first operation comprises emitting a first audio.

9. The system of claim 1, wherein the first operation comprises adjusting a setting of the audio emitting device.

10. A method for controlling an audio emitting device, comprising:
receiving a first biometric input from a biometric sensor;
causing an audio emitting device to conduct a first operation based on the first biometric input;
receiving a second biometric input from the biometric sensor; and
causing the audio emitting device to conduct a second operation based on the second biometric input.

11. The method of claim 10, further comprising identifying the first biometric input is associated with a first person, wherein the first operation is based on the first biometric input and the identity of the first person.

12. The method of claim 11, further comprising identifying the second biometric input is associated with the first person, wherein the second operation is based on the second biometric input and the identity of the first person.

13. The method of claim 11, further comprising identifying the second biometric input is associated with a second person, wherein the second operation is based on the second biometric input and the identity of the second person.

14. The method of claim 10, wherein causing the audio emitting device to conduct the first operation based on the first biometric input includes:
communicating with an external device, the external device including a relationship between the first biometric input and the first operation; and
causing the audio emitting device to conduct the first operation based on the relationship between the first biometric input and the first operation.

15. The method of claim 10, further comprising providing a first feedback after receiving the first biometric input, wherein the first feedback comprises an indication of the first operation commencing.

16. The method of claim 10, wherein the first operation comprises emitting a first audio.

17. The method of claim 10, wherein the first operation comprises adjusting a setting of the audio emitting device.

18. A non-transitory computer-readable medium comprising instructions stored thereon that when executed by one or more processors cause a control system to control an audio emitting device to conduct one or more operations, the controlling comprising:
receiving a first biometric input from a biometric sensor;
causing an audio emitting device to conduct a first operation based on the first biometric input;
receiving a second biometric input from the biometric sensor; and
causing the audio emitting device to conduct a second operation based on the second biometric input.

19. The non-transitory computer-readable medium of claim 18, wherein the controlling further comprises identifying the first biometric input is associated with a first person, and wherein the first operation is based on the first biometric input and the identity of the first person.

20. The non-transitory computer-readable medium of claim 18, wherein the controlling further comprises identifying the second biometric input is associated with a second person, and wherein the second operation is based on the second biometric input and the identity of the second person.
